(19) United States
(12) Patent Application Publication
(10) Pub. No.: US 2026/0232527 A1
(43) Pub. Date: Aug. 13, 2026

(54) HEADBAND WITH VIBRATIONAL ELEMENTS

(71) Applicant: Robert Allen Lewandowski, Webster, NY (US)

(72) Inventor: Robert Allen Lewandowski, Webster, NY (US)

(21) Appl. No.: 19/051,733

(22) Filed: Feb. 12, 2025

(51) Int. Cl. A61H 23/02

(52) U.S. Cl. CPC A61H 23/0254; A61H 2201/1604; A61H 2201/165; A61H 2201/5005; A61H 2205/021

(57) ABSTRACT

A headband with headpiece and cap variations that includes a plurality of coreless DC motors arranged about the circumference of the headband, and a microcontroller programmed to randomly actuate each coreless DC motor wherein vibrations are delivered by the coreless DC motors to a user's head.

### FIELD OF THE INVENTION

The present invention generally relates to headbands with headpiece and cap variations designed to introduce vibration therapies to a user's head for treatments related to various ailments and diseases, such as Parkinson's Disease.

### BACKGROUND

Applying vibrations on the head to treat Parkinson's disease aims at alleviating symptoms associated with this neurodegenerative disorder. Parkinson's disease is characterized by motor symptoms such as tremors, rigidity, bradykinesia (slowness of movement), and postural instability, as well as non-motor symptoms like depression and cognitive decline. Traditional treatments, such as medications like levodopa, focus primarily on managing symptoms but often come with side effects and diminishing effectiveness over time.

Researchers have explored using vibrational therapy as a non-invasive method to stimulate the brain and improve motor function in individuals with Parkinson's disease. The theory behind this approach is that vibrations applied to specific areas of the head or neck can influence neural activity and enhance the communication between brain regions that are disrupted in Parkinson's disease. These vibrations may help modulate abnormal brain rhythms and improve the function of motor circuits, leading to a reduction in symptoms like tremors and muscle stiffness. Vibration therapy could offer a complementary or alternative treatment option for Parkinson's disease, providing relief for patients with fewer side effects than traditional medications.

Current vibrational treatment options can be bulky and inconvenient to use. Current vibrational treatment options are also unconcealed. Therefore, there is a long-felt need in the market for an improved device for introducing vibration therapy for Parkinson's disease that is convenient to use and that may be relatively concealable for the user.

### SUMMARY OF THE INVENTION

Disclosed is a headband with a headpiece, a plurality of coreless DC motors arranged about the circumference of the headpiece, and a microcontroller programmed to randomly actuate each coreless DC motor.

In some embodiments of the headband, each motor sequence time is between 100 to 400 milliseconds (ms). In some embodiments of the headband, after the motor running time sequence is complete, a resting period is started between 800 and 1500 ms with no motor actuations.

In some embodiments of the headband, a random number is generated from a sequential set of integers 1 through m wherein m equals the number of coreless DC motors. The symbol m is representative and other variable symbols may be used. In some embodiments of the headband, two or more coreless DC motors are activated simultaneously.

In some embodiments of the headband, vibration frequency and amplitude of the coreless DC motors are adjustable. In some embodiments of the headband, the vibration frequency of the coreless DC motors is adjustable between 1 and 400 Hz.

Another embodiment is a cap, where the cap includes the headband and includes a crown covering at least a portion of a head, the crown having an opening at the back of the crown. Included is a visor attached to the front of the crown, a backstrap extending across the crown opening at the back of the crown, the plurality of coreless DC motors arranged along and secured to the backstrap, and the microcontroller programmed to randomly actuate each of the coreless DC motors.

In some embodiments of the cap, each motor sequence time is between 100 to 400 ms. In some embodiments of the cap, after the motor running time sequence is complete, a resting period is started between 800 and 1500 ms with no motor actuations.

In some embodiments of the headband, the vibration frequency of the coreless DC motors is adjustable. In some embodiments of the headband, the vibration frequency of the coreless DC motors is adjustable between 1 and 400 Hz.

In some embodiments of the cap, a random number is generated from a sequential set of integers 1 through m wherein m equals the number of coreless DC motors. In some embodiments of the cap, two or more coreless DC motors are activated simultaneously.

Also disclosed is a method for using the headband related to its placement on the head and the application of vibrations where coreless DC motors are randomly or semi-randomly actuated, the particulars which will be detailed.

These and other objects, features, and advantages of the present invention will become readily apparent upon a review of the following detailed description of the invention, in view of the drawings and appended claims.

### BRIEF DESCRIPTION OF THE DRAWINGS

The nature and mode of the operation of the present invention will now be more fully described in the following detailed description of the invention taken with the accompanying drawing figures, in which:

FIG. 1 illustrates a representative headband headpiece embodiment with coreless DC motors as worn by a person;

FIG. 2 illustrates a second view of representative headband headpiece embodiment with coreless DC motors;

FIG. 3 illustrates a representative headband cap embodiment with coreless DC motors;

FIG. 4 illustrates a representative coreless DC motor;

FIG. 5 illustrates a representative power and control system schematic;

FIG. 6 illustrates representative random number generation and coreless DC motor activation determination;

FIG. 7 illustrates an exemplary random number sequence;

FIG. 8 illustrates a vibration amplitude and frequency diagram; and,

FIG. 9 illustrates a representative method of operating the present invention.

### DETAILED DESCRIPTION OF THE INVENTION

Following are detailed descriptions of various related concepts related to, and embodiments of, methods and apparatus according to the present disclosure. It should, however, be understood that this disclosure is not limited to the particular methodology, materials, and modifications described and, as such, may, of course, vary. It is also understood that the terminology used herein is to describe particular aspects only and is not intended to limit the scope of the claims.

Furthermore, it should be appreciated that drawings are representative to illustrate the inventive concepts herein and may not be to scale. Also, like drawing numbers on different drawing views identify identical, or functionally similar, structural elements where there could appear some variations on exactness where exactness is not material to the inventive concept herein. It is to be understood that the claims are not limited to the disclosed aspects.

Unless defined otherwise, all technical and scientific terms used herein have the same meaning as commonly understood to one of ordinary skill in the art to which this disclosure pertains. It should be understood that any methods, devices, or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. It should be appreciated that the term “distal” and comparably related terms denoting further-away portions of an item are antonymous to proximal portions of the co-described item as those portions of items may be termed. The term “approximately” is intended to mean values within ten percent of the specified value.

It should be understood that the use of “or” in the present application is with respect to a “non-exclusive” arrangement unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, when referring to a set or group of items, for illustration (A, B, C) the term “at least one or more . . . and . . . ” such as in “at least one or more of A, B, and C” is intended to include any to all of the denoted set or group of items, i.e. it could include just one item from the set or group, it could include all of the items from the set or group, and it could include any other combination of the set or group of items that is greater than one item and less than all of the items, the illustrated example having three items meaning there are up to seven non-ordered combinations A, B, C, AB, AC, BC, ABC. Other numbers of items would have maximum combination possibilities calculated accordingly.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein.

The term “between” as used in this disclosure includes the value denoting the endpoints of the set. For illustration, a value between A and B includes A and any value A that is less than B and it includes B and any value that is greater than A, according to the discrete or continuous limitations of what value in the set can constitute a value.

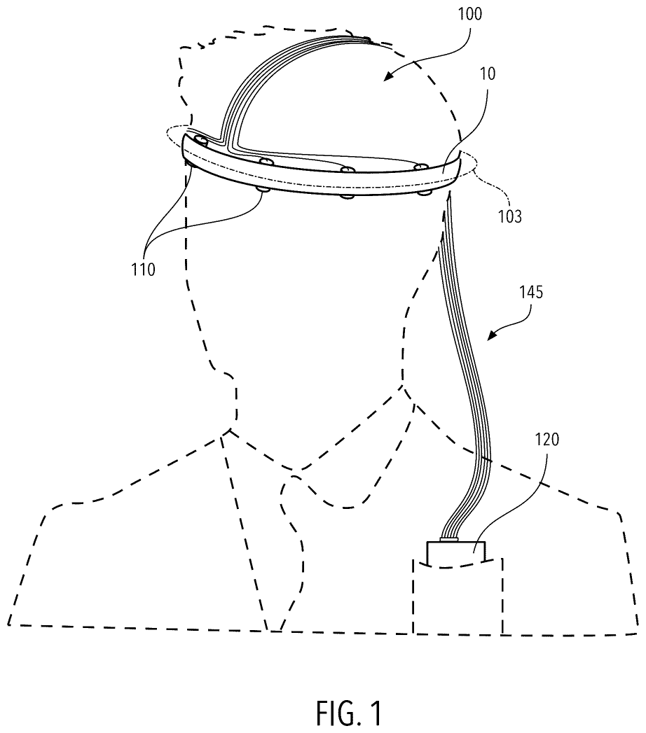

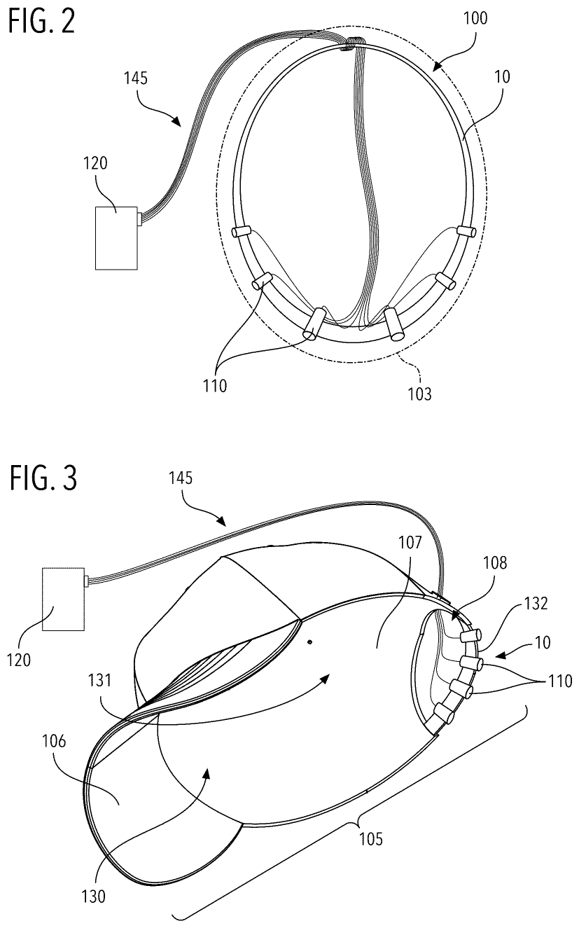

Disclosed in FIGS. 1 and 2 are illustrations of representative headband 10 with headpiece 100, a plurality of coreless DC motors 110 arranged about a circumference of headpiece 103, and a microcontroller 120 programmed to randomly actuate each coreless DC motor 110. Included in the representative embodiment is a ribbon cable 145 designed to be used for power and data. Other cables may be used, and power cables may be designed exclusively for power in embodiments where data is transmitted wirelessly. (Note, FIG. 2 includes perspective and does not reflect relative sizes of motors which are, in preferred embodiments, identical coreless DC motors 110 of the same size.)

FIG. 3 illustrates another embodiment of which headband 10 is the operative part that is a cap 105 and also includes a crown 107 covering at least a portion of a user's head, crown 107 having an opening 108. Included is a visor 106 attached to a front portion 130 of crown 107, a backstrap 132 extending across the crown opening 108 at a back portion of the crown 131, the plurality of coreless DC motors 110 arranged along and secured to backstrap 132; and microcontroller 120 programmed to randomly actuate each coreless DC motor 110. Cap 105 does not change the operations of headband 10 but provides the functional added benefit of at least partly concealing operative parts. Included in the representative embodiment is a ribbon cable 145 designed to be used for power and data. Other cables may be used, and power cables may be designed exclusively for power in embodiments where data is transmitted wirelessly. Although FIG. 2 illustrates six coreless DC motors 110 and FIG. 3 illustrates four coreless DC motors 110, these examples are representative. Other quantities may be used. Further, though the representative examples of coreless DC motors 110 are evenly spaced, other spacing arrangements may be used, particularly to fine tune contact points for given users, such as to target specific nerves or blood vessels.

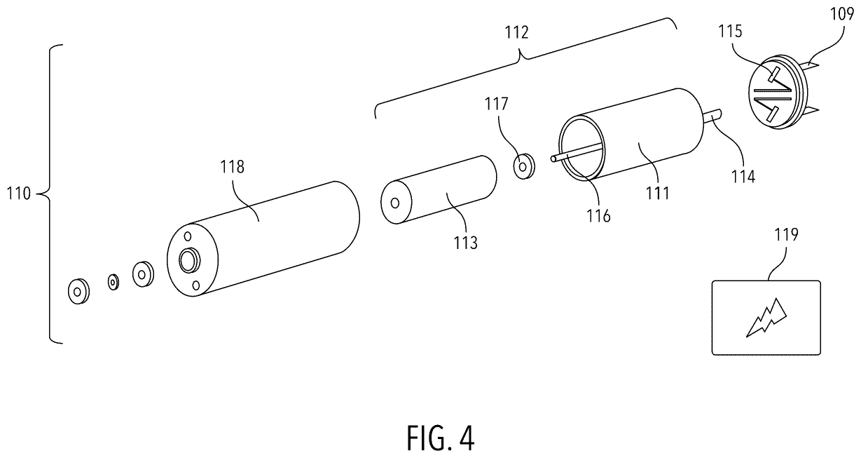

FIG. 4 illustrates a representative coreless DC motor 110. Coreless DC motor 110 is a type of direct current (DC) motor that differs from traditional DC motors in its construction and performance characteristics. Unlike conventional DC motors, which have a core made of iron or another ferromagnetic material, coreless DC motor 110 does not have an iron core in its rotor. Instead, the rotor is typically made of a lightweight, cylindrical coil of wire, which may further be wound in a honeycomb or skewed pattern around a support structure. Suitable for the invention, therefore, the coreless DC motor 110 offers reduced rotational inertia, efficiency, and fine motion control. Many types of coreless DC motors can be used. Illustrated coreless DC model 110, therefore, includes features common to coreless DC motors: a rotor winding 111 made up of a winding of copper wire without an iron core, a stator 112 containing permanent magnets 113 that create a magnetic field, a commutator 114 which is a mechanical switch designed to periodically reverse the current direction in the rotor windings 111 to maintain continuous rotation, brushes 115 designed to transfer electrical current from a power source to the rotor windings 111 via the commutator 114, a rotor shaft 116 designed to provide mechanical output for coreless DC motor 110, allowing it to drive gears, bearings 117 used to support the rotor shaft 116 and allow rotor shaft 116 to rotate smoothly with minimal friction, a housing 118 designed to enclose the aforementioned coreless DC motor 110 parts, and terminals 109 designed to be connected to power supply 119. In a preferred embodiment, motor 110 is a Tatoko® DC coreless waterproof motor, 1.5-3v, 8000-16000 RPM.

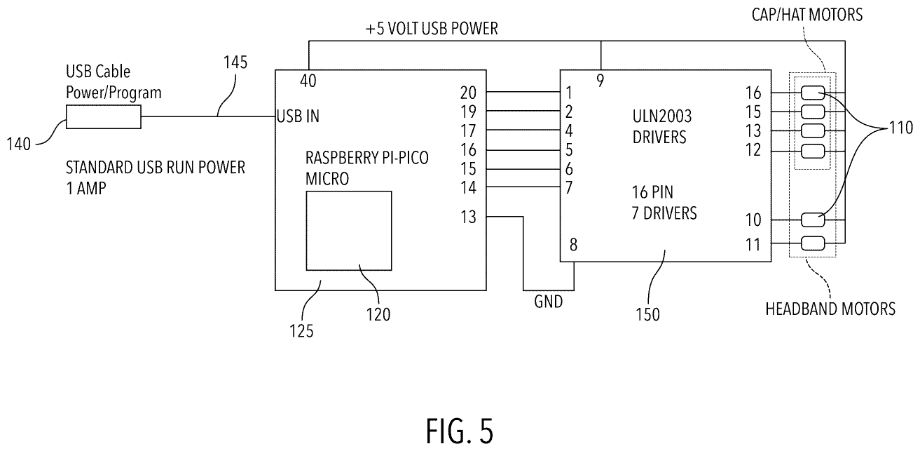

FIG. 5 illustrates a representative schematic that includes USB power supply 140, which is one embodiment of power supply 119 from FIG. 4, microcontroller 120, microcontroller board 125, and integrated circuit 150. The representative embodiment is a Pico built around Raspberry Pi Foundation's RP2040 microcontroller chip, which features a dual-core ARM Cortex-M0+ processor running at up to 133 MHz, along with 264 KB of SRAM and 2 MB of onboard flash memory for storing code and data. Other microcontroller boards may be used. Integrated circuit 150 in the representative example is a ULN2003 that contains seven configurations of two transistors designed to amplify current. Each pair, in the representative example, can drive a load with up to 500 mA of current and handle voltages up to 50V. Other integrated circuit designs can be used. Microcontroller 120, microcontroller board 125, and integrated circuit 150 are operationally connected to coreless DC motors 110, with six coreless DC motors 110 shown in this representative embodiment.

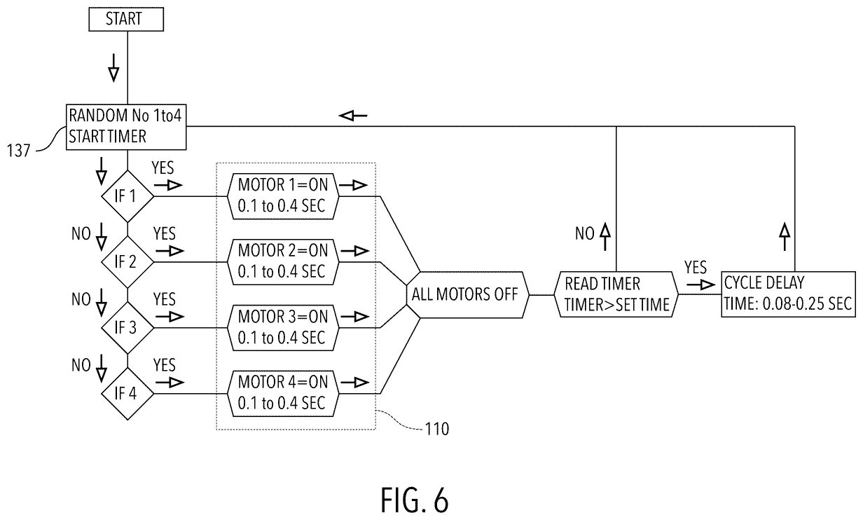

FIG. 6 illustrates a representative sequence of a random number generator 137 generating numbers to determine which of a given plurality of coreless DC motors 110 will be activated in which order. A random number is generated from a sequential set of integers 1 through m wherein m equals the number of coreless DC motors 110 in the given embodiment. In this representative illustration, m=4. While a true random number generator could be used as would be characteristic of cryptography, the purposes of the invention can be handled perfectly well using pseudo-random generators such as, but not limited to, a Linear Congruential Generator (LCG). In this representative example, the LCG produces a sequence of numbers based on the following recurrence relation:

$${X}_{n + 1} = ( a \cdot {X}_{n} + c ) mod m$$

### Where:

Xₙ is the current number in the sequence.
Xₙ₊₁ is the next number.
a is the multiplier.
c is the increment.
m is the modulus.
The seed X₀ is the initial value from which the sequence starts.

In this representative embodiment, the LCG is designed to operate in a full period wherein it is designed to generate every integer in the set {1, 2, . . . , m} exactly once before repeating. The period of an LCG is at most m, and achieving a period of exactly m ensures that each coreless DC motor 110 is selected exactly once per period or cycle. Other random and pseudo-random number generators may be used such as Mersenne Twister, many of which have longer periods than typical LCG before a pattern of integer selection may be repeated. In embodiments where two or more coreless DC motors 110 are activated simultaneously, the random number generator will generate the required number of integers from the set for at or substantially at simultaneous activation.

Representative code for establishing coreless DC motor sequences following the example where m=4 follows:

```
#include <stdio.h>
#include ″pico/stdlib.h″
#include ″ff.h″
import time, _thread, machine
from machine import Pin
import random
import time, _thread, machine
from machine import Pin
led = Pin(25, Pin.OUT)
Motor1 = Pin(15, Pin.OUT) #20
Motor2 = Pin(14, Pin.OUT) #19
Motor3 = Pin(13, Pin.OUT) #17
Motor4 = Pin(12, Pin.OUT) #16
Button = Pin(16, Pin.IN) #21
Button1 = Pin(17, Pin.IN) #22
Motor1.value(0); Motor2.value(0); Motor3.value(0); Motor4.value(0)
led.value(0)
// Sanford timing sequence
sequence=[1,3,2,4,2,4,1,3,1,4,3,2,
      3,4,1,2,3,2,1,4,2,3,4,1 ]
def cycle(y):
    mot = Pin(16 - y, Pin.OUT);
    mot.value(1);
    led.value(1)
    time.sleep( x );
    led.value(0)
    mot.value(0);
    time.sleep(.01);
while True:
  y =(random.randint(1, 4 ))
  x = (random.randint(1, 6 )* .05)
  z = (random.randint(1, 8 ))
  if ( Button.value( ) == 0 ): x = . 15;
  print (′BUT=′,Button.value( ),′delay=′, x ,′ Mot i=′,i,′ z=′,z );
  cycle(sequence[i])
  if (z == 1): time.sleep(1.5),print (′ sleep 1.5′);
  led.value(0);
  Motor1.value(0); Motor2.value(0);
  Motor3.value(0); Motor4.value(0)
```

Representative code for establishing coreless DC motor sequences following the example where m=6 follows:

```
#include <stdio.h>
#include ″pico/stdlib.h″
#include ″ff.h″
import time, _thread, machine
from machine import Pin
import random
import time, _thread, machine
from machine import Pin
import rp2
led = Pin(25, Pin.OUT)
Motor1 = Pin(15, Pin.OUT) #20
Motor2 = Pin(14, Pin.OUT) #19
Motor3 = Pin(13, Pin.OUT) #17
Motor4 = Pin(12, Pin.OUT) #16
Motor5 = Pin(11, Pin.OUT) #16
Motor6 = Pin(10, Pin.OUT) #16
Button = Pin(16, Pin.IN) #21
Button1 =Pin(17, Pin.IN) #22
Button2 =Pin(18, Pin.IN) #24
Motor1.value(0); Motor2.value(0);
Motor3.value(0); Motor4.value(0)
Motor5.value(0); Motor6.value(0);
led. value(0)
sequence=[1,3,2,4,2,4,1,3,1,4,3,2,
        3,4,1,2,3,2,1,4,2,3,4,1 ]
def cycle(y):
      mot = Pin(16 - y, Pin.OUT);
      mot1 = Pin(16 - z, Pin.OUT);
      mot.value(1);
      if ( Button2.value( ) == 1 ): mot1.value(1);
      led.value(1)
      time.sleep( x ); #x
      led.value(0)
      if (Button2.value( ) == 1 ): mot1.value(0);
      mot.value(0);
      time.sleep(.01);
      ## 10 motors cycle 36 deg
while True:
  for j in range(6): #24 sequence
# print(′j=′,sequence[j])
    y=(random.randint(1, 6 )) # old 1 to 4
    X= (random.randint(1, 6 )* .05)
    Z= (random.randint(1, 6))
    if ( Button.value() == 0 ): x = .15;
    if (Button1.value() == 1): y=j+1; #y =sequence[j];
    print (′BUT=′,Button.value( ),′delay=′, x ,′ Mot Rand=′,y,′ j=′, j ,′ z=′,z )
    cycle(y);
    #if (j != 0 ): cycle(y);
    if(j != 0) and ( (j % 5) == 0): print (′sleep12=1.50′), time.sleep(1.5);
    if(Button2.value( ) == 1 ) and (z == 1): time.sleep(1.5),print (′ sleepz=1.5′);
    led.value(0)
    Motor1.value(0); Motor2.value(0);
    Motor3.value(0); Motor4.value(0);
    Motor5.value(0); Motor6.value(0);
```

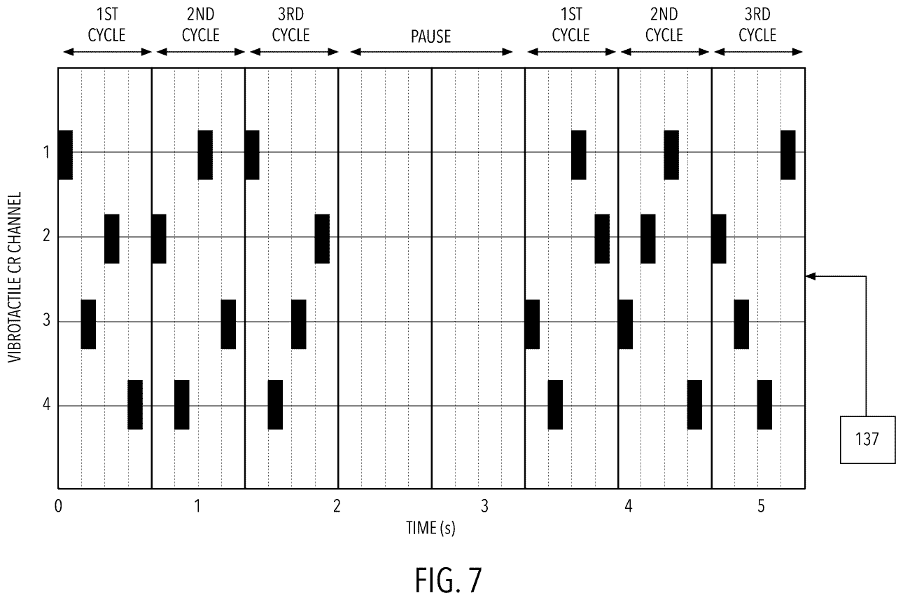

FIG. 7 illustrates one representative example of integer selection as could be expected, the illustrated embodiment has random number generator 137 selecting each integer in set {1, 2, . . . , m} in a randomly generated sequence.

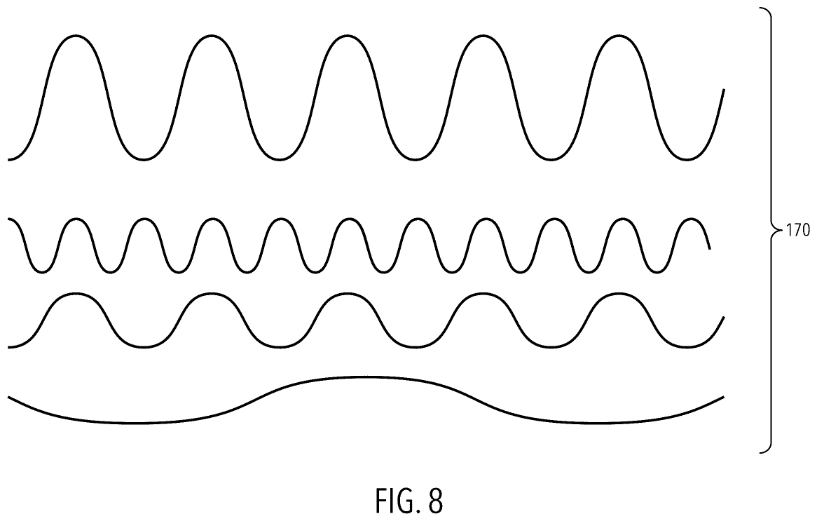

FIG. 8 illustrates frequency diagram 170 in which the frequency and amplitude of vibrations in embodiments are selectable based on the treatment being sought. Adjustments can include either or both amplitude and frequency. In some embodiments, only the frequency is adjustable.

Further disclosed, in some embodiments of headband 10, each motor sequence time is between 100 to 400 ms. In some embodiments of headband 10, after the motor running time sequence is complete, a resting period is started between 800 and 1500 ms with no motor 110 actuations. Headband 10 inclusive of headpiece 100 and cap 105 embodiments can be set for other sequence times and resting periods as may be called for in a given treatment.

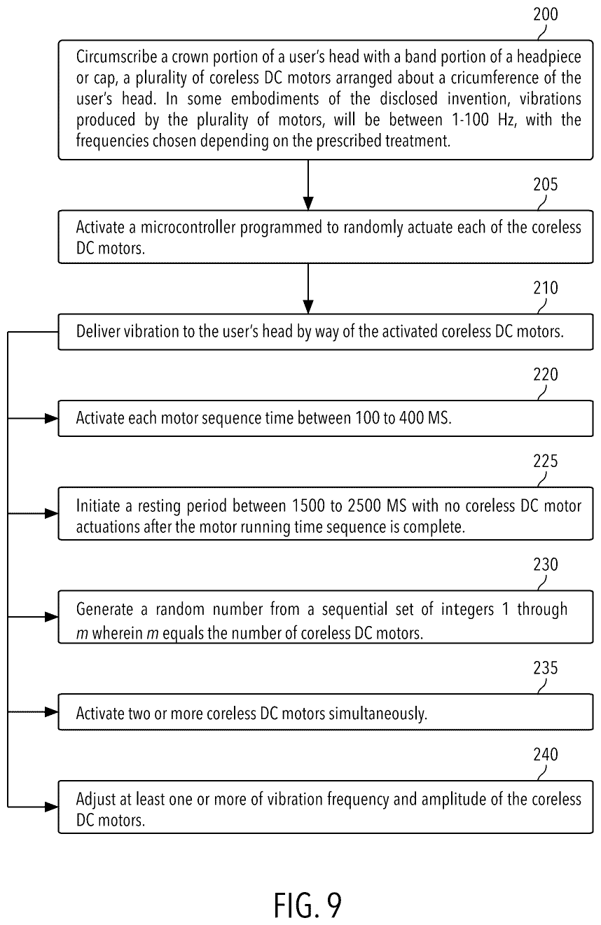

FIG. 9 discloses a method for introducing vibrations to a user's head that includes the step of 200 circumscribing a crown portion of the user's head with headband 10 of headpiece 100 or cap 105, plurality of coreless DC motors 110 arranged about the circumference of the user's head, therefore. In some embodiments of the disclosed invention, these vibrations will be between 1 and 400 Hz), with the frequencies chosen depending upon the prescribed treatment. The method includes the step of 205, activating microcontroller 120 programmed to randomly actuate each coreless DC motor 110. The method includes the step of 210, delivering vibrations to the user's head by way of activated coreless DC motors 110.

The method may include the step of 220, activating each motor sequence time between 100 to 400 ms. The method may include the step of 225, initiating a resting period between 800 and 1500 ms with no coreless DC motor actuations 110 after the motor running time sequence is complete.

The method may include the step of 230, generating a random number from a sequential set of integers 1 through m wherein m equals the number of coreless DC motors 110. The method may include the step of 235, activating two or more coreless DC motors 110 simultaneously. The method may include the step of 240, adjusting at least one or more of vibration frequency and amplitude of coreless DC motors 110.

A general object of the invention is to provide vibrational therapy, particularly for Parkinson's disease and other neurodegenerative diseases, and to do so by replacing continuous action with intermittent action, changing interval or vibrational frequency, and making use of the intervals with intermittent breaks as is conducive to the given therapy. Suitably timed recurrent vibrations delivered randomly may deliver results superior to those delivered by continually administered vibrations or administering vibrations using predictable intervals.

Further, it is a secondary object of the invention to make elements of the system dynamic so they can change to accommodate the 1) placement of coreless DC motors, 2) vibration frequencies, and 3) amplitude when conditions or treatment requirements change.

In some embodiments, the plurality of coreless DC motors 110 are arranged approximately equidistantly radially about and proximate to the base of the skull of the user. Motors may be placed along any portion of the skull, and they may be in direct contact with the user's skull or may have a fabric or other material layer between coreless DC motors 110 and the user's skull. In preferred embodiments, pressure may be generated by or upon the headband 10 and vectored inward through coreless DC motors 110 wherein the inward vectored pressure facilitates vibration transfer to the user.

Various related embodiments of the inventive concept are also described in the drawings, which are incorporated herein by reference in its entirety. The following patents and patent applications are incorporated by reference in their entirety: U.S. Pat. Nos. 11,766,562; 11,691,001; 11,684,771; 11,229,790; 11,027,117; 11,020,603; 10,994,132; 10,835,735; 9,375,571; 9,248,286; 9,227,056; 8,843,201; 8,583,238; 7,769,461; U.S. Patent Publication No. 2022/0313995; U.S. Patent Publication No. 2022/0288383; U.S. Patent No. 2022/0016423; U.S. Patent Publication No. 2021/0346711; U.S. Patent Publication No. 2020/0324075; U.S. Patent Publication No. 2017/0296121; and PCT Application No. WO 2022/221644.

While inventive concepts have been described above in terms of specific embodiments, it is to be understood that the inventive concepts are not limited to these disclosed embodiments. Upon reading the teachings of this disclosure, many modifications and other embodiments of the inventive concepts will come to mind of those skilled in the art to which these inventive concepts pertain, and which are intended to be and are covered by both this disclosure and the appended claims. It is indeed intended that the scope of the inventive concepts should be determined by proper interpretation and construction of the appended claims and their legal equivalents, as understood by those of skill in the art relying upon the disclosure in this specification and the attached drawings.

### REPRESENTATIVE COMPONENTS

10 Headband
100 Headpiece
103 Circumference of Headpiece
105 Cap
106 Visor
107 Crown
108 Opening at the Back of the Crown
110 Coreless DC Motor
111 Rotor winding
112 Stator
113 Permanent magnet
114 Commutator
115 Brushes
116 Rotor shaft
117 Bearings
118 Housing
119 Power Supply
109 Terminals
120 Microcontroller
125 Microcontroller Board
137 Random Number Generator
130 Front Portion of Crown
131 Back Portion of Crown
132 Backstrap
140 USB Power supply
145 Ribbon Cable
150 Integrated Circuit
170 Frequency Diagram

1. A headband, comprising:
a headpiece;
a plurality of coreless DC motors arranged about a circumference of the headpiece, each coreless DC motor configured to be located at a unique position proximal to a user's head; and
a microcontroller configured to randomly actuate the plurality of coreless DC motors and wherein at least one random number is configured to be generated to determine which of the plurality of coreless DC motors will be activated and in which order, where the at least one random number is selected from a sequential set of integers 1 through m, wherein m equals a number of the plurality of coreless DC motors, and
wherein every integer in the sequential set {1, 2, . . . , m} is configured to be generated exactly once before repeating.

2. The headband recited in claim 1, wherein a motor sequence time of each of the plurality of coreless DC motors is between 100 and 400 ms.

3. The headband recited in claim 2, wherein after the motor sequence time is complete, a resting period is configured to be started between 800 and 1500 ms with no motor actuations.

4. (canceled)

5. The headband recited in claim 1, wherein two or more of the plurality of coreless DC motors are activated simultaneously.

6. The headband recited in claim 1, wherein a vibration frequency and an amplitude of the plurality of coreless DC motors are adjustable.

7. The headband recited in claim 6, wherein the vibration frequency of the plurality of coreless DC motors is adjustable between 1 and 100 Hz.

8. The headband recited in claim 1, wherein said plurality of coreless DC motors are configured to be arranged approximately equidistantly radially about and proximate to a base of a skull of a user.

9. A cap, comprising:
a crown configured for covering at least a portion of a head, the crown having an opening at a back of the crown;
a visor attached to a front of the crown;
a backstrap extending across the crown opening at the back of the crown;
a plurality of coreless DC motors arranged along and secured to the backstrap, each coreless DC motor configured to be located at a unique position proximal to a user's head; and
a microcontroller configured to randomly actuate the plurality of coreless DC motors, and wherein at least one random number is configured to be generated to determine which of the plurality of coreless DC motors will be activated and in which order, where the at least one random number is selected from a sequential set of integers 1 through m, wherein m equals a number of the plurality of coreless DC motors, and
wherein every integer in the sequential set {1, 2, . . . , m} is configured to be generated exactly once before repeating.

10. The cap recited in claim 9, wherein a motor sequence time of each of the plurality of coreless DC motors is between 100 and 400 ms.

11. The cap recited in claim 10, wherein after the motor sequence time is complete, a resting period is configured to be started between 800 and 1500 ms with no motor actuations.

12. (canceled)

13. The cap recited in claim 9, wherein two or more of the plurality of coreless DC motors are activated simultaneously.

14. The cap recited in claim 9, wherein a vibration frequency and an amplitude of the plurality of coreless DC motors are adjustable.

15. The cap recited in claim 14, wherein the vibration frequency of the plurality of coreless DC motors is adjustable between 1 and 100 Hz.

16. The cap recited in claim 9, wherein said plurality of coreless DC motors are configured to be arranged approximately equidistantly radially about and proximate to a base of a skull of the user.

17. A method for introducing vibrations to a user's head comprising:
circumscribing a crown portion of the user's head with a band portion of a headband or a cap, a plurality of coreless DC motors arranged about a circumference of the user's head;
activating a microcontroller that is programmed to randomly actuate the plurality of coreless DC motors by way of selecting at least one random number determining which of the plurality of coreless DC motors will be activated and in which order, wherein the at least one random number is generated from a sequential set of integers 1 through m, wherein m equals a number of the plurality of coreless DC motors, generating every integer in the sequential set {1, 2, . . . , m} exactly once before repeating; and
delivering vibration to the user's head by way of the plurality of coreless DC motors that are activated, each coreless DC motor vibrating at a unique position proximal to said user's head.

18. The method for introducing vibrations to the user's head recited in claim 17, further including activating the plurality of coreless DC motors so that a motor sequence time of each of the plurality of coreless DC motors is between 100 and 400 ms.

19. The method for introducing vibrations to the user's head recited in claim 18, further including initiating, after the motor sequence time is complete, a resting period between 800 and 1500 ms with no coreless DC motor actuations.

20. (canceled)

21. The method for introducing vibrations to the user's head recited in claim 17, further including activating two or more of the plurality of coreless DC motors simultaneously.

22. The method for introducing vibrations to the user's head recited in claim 17, further including adjusting at least one or more of a vibration frequency and an amplitude of the plurality of coreless DC motors.
